(19) United States
(12) Patent Application Publication
(10) Pub. No.: US 2025/0120545 A1
(43) Pub. Date: Apr. 17, 2025

(54) SYSTEM TO REMOVE FOOD PARTICLES FROM A VAT FOR CONTINUOUSLY COOKING FOOD

(71) Applicant: MP EQUIPMENT, LLC, Gainesville, GA (US)

(72) Inventors: Allen ZANDI, Gainesville, GA (US); Michael BELL, Gainesville, GA (US)

(21) Appl. No.: 18/917,682

(22) Filed: Oct. 16, 2024

Related U.S. Application Data
(60) Provisional application No. 63/544,488, filed on Oct. 17, 2023.

(51) Int. Cl. A47J 37/12

(52) U.S. Cl. CPC A47J 37/1223; A47J 37/1266; A47J 37/1285

(57) ABSTRACT

An oil receiving system is provided and includes a housing with front, side, and a bottom wall, the front wall configured to be connectable to an outer edge of a vat, the combined front, side, and bottom walls form a plenum for receipt of oil therein. A fluid connection is disposed in either the side wall or the bottom wall, the fluid connection vertically disposed below a top edge of the front wall. A piped system allows flow from within the plenum through the fluid connection. A valve is disposed at or proximate to the fluid connection and operable to either allow flow from the plenum through the fluid connection or prevent flow from the plenum through the fluid connection. The oil receiving system can be provided with a vat for frying foods or as a separate item that is attached to a vat after the vat has been installed.

### CROSS-REFERENCE TO RELATED APPLICATIONS

This application claims priority from U.S. Provisional Application No. 63/544,488, filed Oct. 17, 2023, the entirety of which is hereby incorporated by reference herein.

### BACKGROUND OF THE INVENTION

This application relates to commercial system to cook food items in liquid, where the liquid is directly exposed to the food being cooked, such as deep fat fryers. Over time with continuously cooking food items within the liquid, crumbs or particles of food being cooked often fall off the food and into the liquid. The subject specification relates to systems to remove the crumbs or particles of food that fall into the liquid over time.

### SUMMARY OF THE INVENTION

A first representative embodiment of the disclosure is provided. The embodiment is directed to an oil receiving system. The oil receiving system includes a housing that includes a front wall, a side wall, and a bottom wall, the front wall being configured to be connectable to an outer edge of a vat, the combined front wall, side wall, and bottom wall form a plenum for receipt of oil therein. A fluid connection is disposed in either the side wall or the bottom wall, the fluid connection vertically disposed below a top edge of the front wall. A piped system is provided that allows flow from within the plenum through the fluid connection. A valve is disposed at or proximate to the fluid connection and operable to either allow flow from the plenum through the fluid connection or prevent flow from the plenum through the fluid connection.

Another representative embodiment of the disclosure is provided. The embodiment includes a system to remove foreign matter from cooking oil. The system includes a vat that receives a volume of heated oil for cooking food products therein, the oil establishes a nominal top oil surface during heated cooking operations within the vat, the vat supporting a conveyor system that causes movement of a food product from an inlet end to an exit end of the vat, the vat is configured to receive the volume of heated oil such that the nominal top oil surface is above at least a portion of the conveyor system, a sidewall of the vat extends vertically above the nominal top surface of the oil, the sidewall includes an entry portion, right and left side portions, and an exit portion, wherein the entry portion is proximate to a position where the food product initially enters into the vat and onto the conveyor system, and the exit portion is proximate to a different position where the food product exits the vat after reaching an opposite end of the conveyor system. An overflow plenum is provided and is in fluid communication with the volume of heated oil, the overflow plenum is fixed to the vat such that a transition from the vat to the overflow plenum is at a height that is vertically lower than the nominal top surface of the oil within the vat to allow oil to flow from the vat and into the overflow plenum. The overflow plenum includes a housing that includes a front wall, a bottom surface, at least one side surface, and an overflow surface that is fixed to a sidewall of the vat. The vat is at the location of transition to the overflow plenum includes a top edge of the respective sidewall that is at the same height as or slightly lower than the height of the nominal top surface of the oil.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a perspective view of a section food cooking system (specifically continuous deep frying system) that includes an overflow plenum for receipt of oil to be filtered.

FIG. 1a is a front perspective view of section the food cooking system of FIG. 1, which does not depict a front end wall of the vat.

FIG. 2 is a schematic view of the food cooking system, overflow plenum, and filtration system of the system of FIG. 1.

FIG. 3 is a left side cross-sectional view of the system of FIG. 1.

FIG. 4 is a detail view of detail A of FIG. 3.

FIG. 5 is a perspective view of the overflow plenum, its connection to the frying vat, and a portion of the filtration system.

FIG. 6 is a detail view of the overflow plenum of FIG. 5, showing an isolation door for the overflow plenum shut to prevent oil to flow from the vat into the overflow plenum.

FIG. 7a is a schematic view of a first movable container to receive oil therein but in a position to prevent oil flow into the overflow plenum.

FIG. 7b is a schematic view the movable container of FIG. 7a moved to a position to dump oil from therein but prevent oil to flow into the movable container.

FIG. 8a is an alternate movable container to receive oil therein but in a position to prevent oil flow into the overflow plenum.

FIG. 8b is a schematic view of the movable container of FIG. 8a moved to a position to dump oil therefrom but prevent oil to flow into the movable container.

FIG. 9a is a schematic view of possible bottom wall design of the overflow plenum.

FIG. 9b is a schematic view of another possible bottom wall design of the overflow plenum.

FIG. 10 is a top perspective view of an embodiment of the overflow plenum of FIG. 1.

FIG. 11 is a front perspective view of the overflow plenum of FIG. 10.

FIG. 12 is a front view of the overflow plenum of FIG. 10.

### DETAILED DESCRIPTION OF THE INVENTION

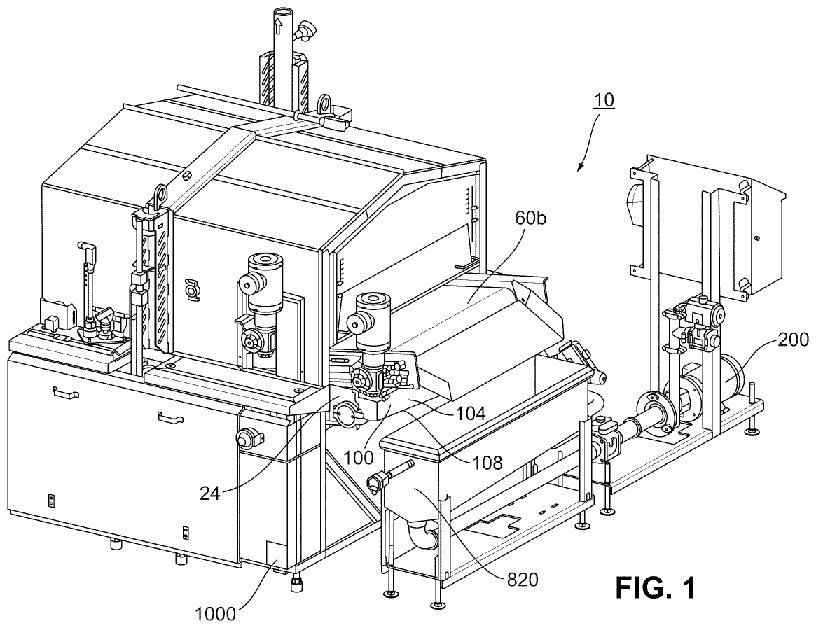

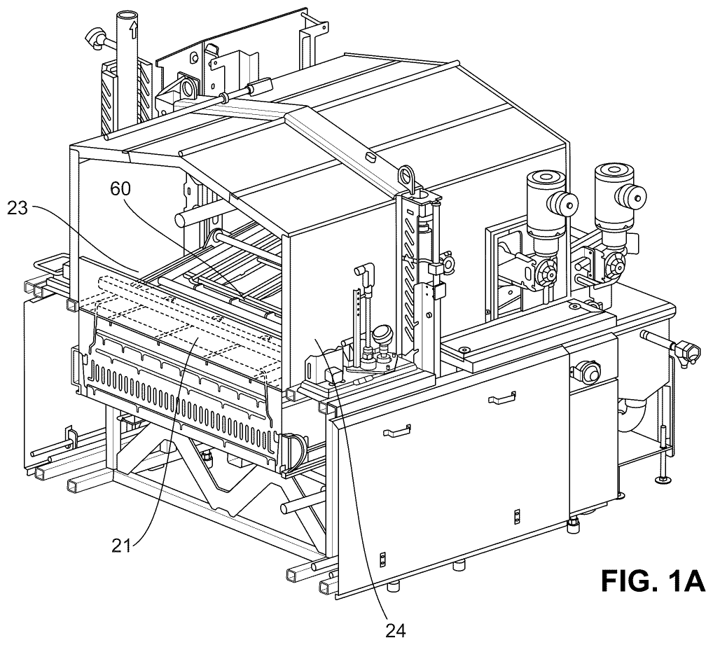

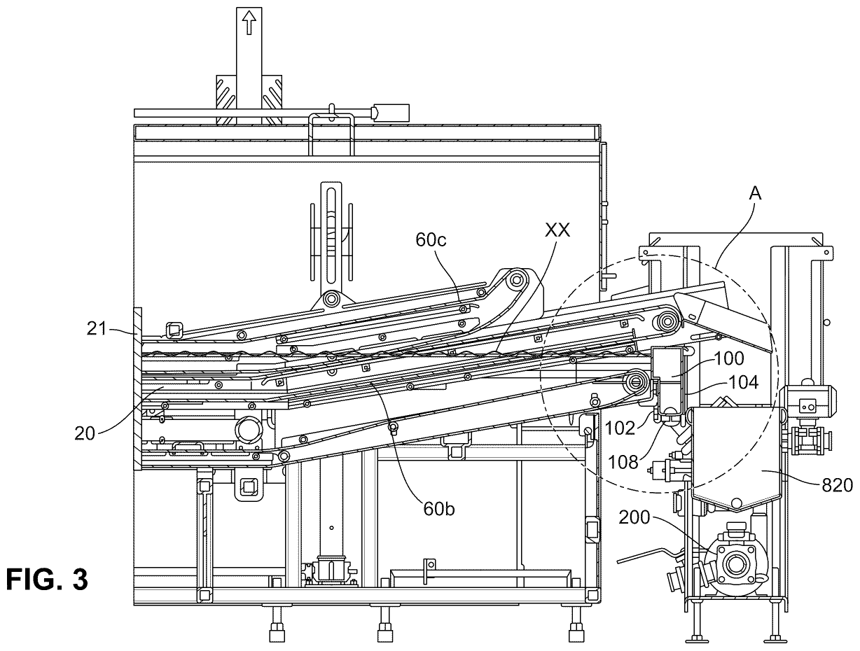

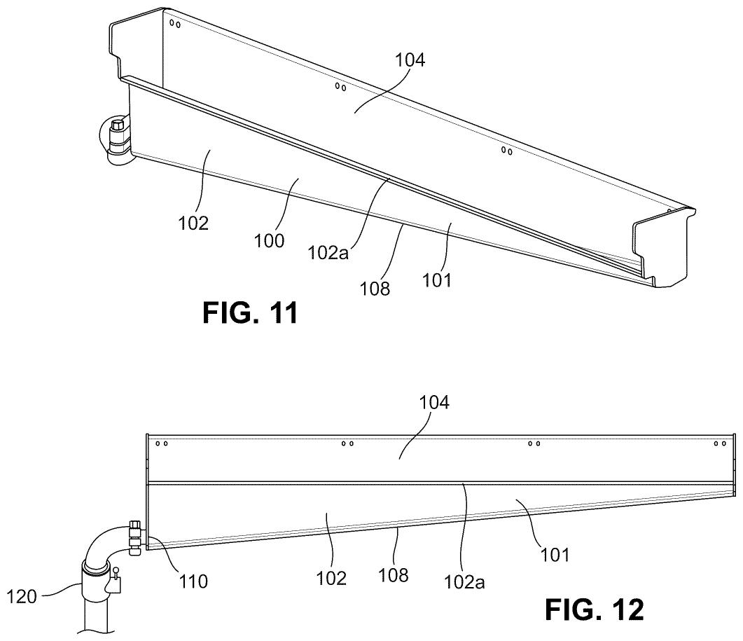

Turning now to FIGS. 1-12, a system 10 to remove foreign matter from cooking oil within a cooking system is provided. The cooking system is depicted herein as a deep fat fryer that is configured for frying foods that are moved through the vat 20 via a conveyor belt 60, but other types of cooking systems that cook with hot oil, or water, or other liquids may be provided with the system 10 in other embodiments. For the sake of brevity, this specification will describe in detail the system for use with frying foods with hot cooking oil. One of ordinary skill in the art with a thorough review and understanding of this specification will readily comprehend how the system 10—may be used, and the modifications needed for use, with other cooking liquids and with vats that do not use a conveyor to move food to be cooked through the vat with merely routine optimization. Any substantive structural or functional differences for use with the system with other types of cooking fluids or other motive features will be specifically discussed herein.

The food that can be cooked within the system 10 may be anything that is desired to be cooked by complete or partial frying in hot oil, and specifically by facilities that cook a large amount of food by frying. The food may be chicken fingers or chicken nuggets, other protein than chicken, or potatoes, vegetables, cheese, and the like. The system 10 is configured in a similar manner for cooking different foods by frying and to vary the amount of cooking (fully cooking, half cooking, etc.) and the amount of frying and the type of foods to be fried do not have any significant impact upon the design of the system 10 other than an impact of the design and operation of the vat, the operation of the conveyors, the temperature of the heating oil, and the flow of the heated oil within the vat-all of which are of which can be optimized by one of ordinary skill in the art with a thorough review of the this specification and a good understanding of the cooking that is desired of the food item within the vat 20.

The system 10 may be used with a vat 20, such as a vat that includes heated cooking oil for frying foods disposed in the heated oil. The cooking oil X may be heated with gas burners or electrical heating elements as is well known in the art. The oil X may be heated within the vat 20, while in other embodiments, the oil may receive heat from a heat exchange system that is located outside of the vat and the oil flows out of the vat 20 to receive the heat and then returns to the vat to provide the heat input into the vat 20.

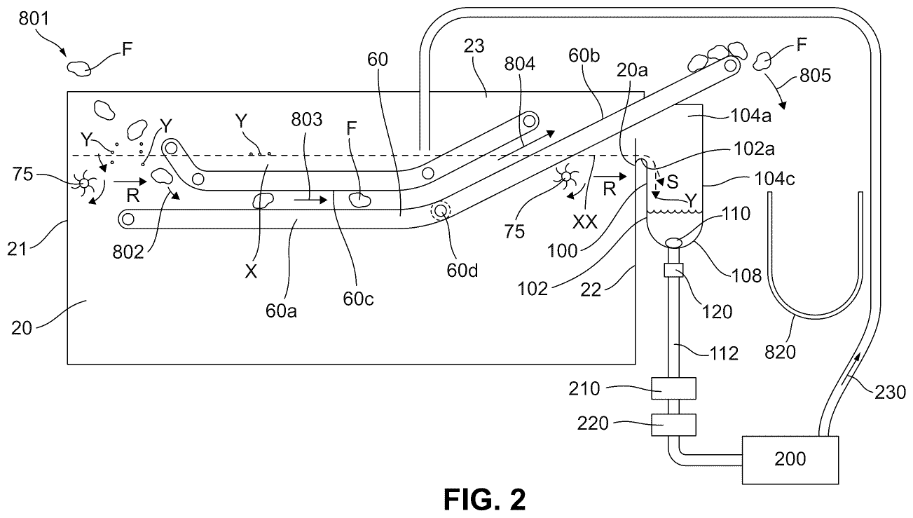

The vat 20 may include one or more conveyor systems 60 that urge foods that are received within the vat 20 to move to another portion of the vat during the cooking process. The conveyor systems 60 may be timed to move the food items received thereon at a speed that causes the food items that are received within the vat to transition to an exit portion of the vat 20 at the same time that the food is fully cooked (or fully processed) within the vat according to the desired functionality of the vat 20. In some embodiments, the conveyor system 60 may include a single conveyor, while in other embodiments, the conveyor system 60 may include multiple conveyors, such as two conveyors. In this embodiment, a first conveyor 60a within the system may receive the food item when it is first deposited into the vat and transition the food item along portion of the vat 20 and through the oil within the vat associated with the desired cooking step, and upon reaching an end of the first conveyor 60a the food item may be deposited upon a second conveyor 60b (FIG. 2 depicts 60a and 60b as the same conveyor—but these can be two different conveyors where food from 60a flows onto 60b, such as at a neighboring position 60d) to move the food item out of the vat and toward a next step in the cooking process. In some embodiments including the embodiment depicted in the figures a third conveyor 60c may be provided. The third conveyor 60c is positioned above a significant portion or the entirety of the first conveyor 60a and particularly the portion of the first conveyor 60a that extends below the nominal top surface XX of the cooking oil, with the second conveyor 60c provided to cause the food that moves between the first and third conveyors 60a, 60c to transition below the nominal top surface of the cooking oil. The term nominal top surface is defined herein to be a plane that extends through the top surface of the oil within the vat if the amount of oil in the vat 20 were completely still. The third conveyor 60c is provided to maintain the food item between the first and third conveyors 60a, 60c and specifically to maintain the food items therebetween within the and surrounded by oil within the vat 20. The conveyors within the conveyor system 60 may be any type of conveyor known in the art to support a food item thereon (or thereunder in the case of an upper conveyor 60c) and to allow the cooking oil to flow therethrough in order for heated oil to contact the outer surfaces of the food as the food is moved along the first conveyor through the vat. Accordingly, the conveyors, and specifically the first and third conveyors 60a, 60c that support the food as it is cooked within the oil may be include wires or other thin structures that provide mechanical support to the food item, but minimize the contact with the food to maximize the contact of the food with the cooking oil.

In some embodiments, the conveyor(s) 60 may include a continuous flat belt type conveyor (with a plurality of holes through the flat belt to allow the oil to flow therethrough). The conveyor(s) may also be flat (such that food items rest thereon) but discontinuous such that there are periodically portions that support food thereon and between them portions that do not support food thereon. Still alternatively, the conveyor may include a plurality of spaced apart baskets that support foods therein.

The vat 20 includes outer side walls that retain the oil therewith and provide structural support for the conveyors, the oil heating equipment, and other equipment that is associated with cooking within the vat 20. The outer side walls include first and second end walls 21, 22, which are proximate to the positions where the food is introduced into the vat (the entry portion) and the position where the food is removed from the vat (the exit portion, often at an opposite end portion of the vat from the entry portion), respectively. The vat 20 additionally includes side walls 23, 24 that extend between the first and second end walls.

Each of the end walls and the two side walls 21, 22, 23, 24 include a top edge that is located at a height that is above the nominal top surface XX of the oil within the vat to prevent the oil from leaving the vat 20 by spilling over the sides. The top edge of the end walls and the two side walls of the vat is additionally above the highest expected oil level within the vat during operations and at a height that would prevent oil splashes created during normal operation of the system to escape the vat. One of ordinary skill in the art with a thorough review of this specification and routine experimentation of the oil's typical transients during normal operation of the system 10 can readily establish a height of the walls of the vat to prevent significant oil from leaving the vat over the side walls during normal operation (not including the oil flowing into the overflow plenum 100 as discussed herein).

The vat 20 may support one or more overflow plenums 100 that are fixed upon of the end walls or the side walls of the vat 20. The vat 20 may support one overflow plenum 100, while in other embodiments, the vat may support multiple overflow plenums 100 located upon different end walls or side walls of the vat 20.

In the embodiment described and depicted herein, the overflow plenum 100 is disposed connected to the rear end wall 22, to receive crumbs that accumulate at the top surface XX of the oil proximate to the rear end wall 22. In other embodiments another overflow plenum 100, or an alternative overflow plenum 100 may be disposed upon the front end wall 21 to receive crumbs that are within the top surface XX of the oil proximate to the front end wall 21. Alternatively or additionally, other or additional overflow plenums 100 may be positioned upon one or both of the right and left side walls 23, 24 to receive oil therefrom. If multiple overflow plenums are provided the controller 1000 (discussed herein) may operate the overflow plenums (and specifically the valves 120 that are downstream thereof, the filtration system 200 and the associated components to sequentially receive oil from the differing overflow plenums 100, such as receive oil from the plenum at the front end wall 21 and filter that oil and return that oil, and then receive oil from the plenum 100 at the rear end wall 22 and filter that oil and return that oil to the vat 20 and so forth. Alternatively, the two or more overflow plenums 100 may operate in an as-needed basis, based upon timers that operate the various plenums 100 based upon duty cycles or on an as needed basis based upon a sensed amount of crumbs or other foreign matter over a given concentration identified as within the oil, as discussed herein.

The overflow plenums 100 are arranged to be in fluid communication with the oil within the vat 20, to receive oil that flows from the vat 20, either by forced flow of oil from the vat, or due to natural flow that occurs with movement of the conveyors 60 within the vat 20 and other activities associated with frying food within the vat.

The overflow plenums 100 includes a housing 101, that includes a front wall 102, and a side wall 104. In embodiments where the overflow plenum is rectangular, the side wall 104 includes right and left side walls 104a, 104b and a rear wall 104c that extends between ends of the right and left side walls 104a, 104b. The other ends of the right and left side walls 104a, 104b connect with ends of the front wall 102. The combination of the front wall (overflow surface) 102, and the side wall 104, and a bottom wall 106 define an internal volume that is configured to receive oil therein that flows into the overflow plenum 100 from the vat.

The front wall 102 is fixed with respect a wall of the vat, such that a top edge 102a of the front wall 102 (also described herein as an overflow surface) is disposed at or just slightly above a top edge 20a of the wall of the vat that receives the overflow plenum 100. In locations where the overflow plenum 100 is attached to an existing vat 20 (i.e. as a modification to the vat 20 and sold or assembled separately from the vat), the wall of the vat 20 that receives the overflow plenum 100 is constructed or modified (such as if the overflow plenum 100 is attached to the vat 20 after the vat was constructed) such that the top edge 20a of the wall of the vat 20 and top edge 102a of the front wall 102 is at or a small distance lower (i.e. slightly lower) than a nominal height of the oil XX within the vat 20 during normal cooking operations within the vat 20. The term small distance lower/slightly lower is defined herein to be about a centimeter or less than a centimeter that the reference height (i.e. the reference height is the height of the nominal top surface of the oil during operation of the system 10). Accordingly, because the top edge 102a of the overflow plenum 102a is at or a small distance lower than the height of the nominal top surface XX of the oil, oil from the vat 20 flows into internal volume 100a of the overflow plenum 100. The oil may flow into the overflow plenum due to normal oil currents established within the vat 20, such as due to operation of the conveyors that cause oil movement (arrows R, schematic), and in some embodiments, the vat 20 may have mechanisms that cause forced oil flow within the vat 20, such as impellers 75 (schematic), pumps, and the like.

In some embodiments, the overflow surface—that includes the top edge 102a of the front wall, and may include the top edge of the wall of the vat 20 that receives the overflow plenum 100 is formed with a convex upward orientation to cause oil that flows to the top edge to continue flowing into the overflow plenum 100.

The oil that enters the overflow plenum 100 flows therein until the overflow plenum 100 is full to the same level as the nominal top surface XX of the vat. In this situation some of the oil may in some circumstances flow from the overflow plenum 100 to return to the vat. In some embodiments, the transition between the vat 20 and the overflow plenum 100 may be formed with the top edge 102a formed upon a ramp surface that extends upwardly from the vat 20 and toward the top edge 102a, which is the highest point in the ramp surface. This construction may minimize the ability of oil, and specifically objects that are floating within the oil to flow from the overflow plenum 100 and into the vat 20, due to the difficulty of the objects to flow over the top edge 102a (which is the highest point in the transition) and into the vat 20.

As schematically depicted in FIG. 2, during frying processes within the vat, crumbs (Y, schematic) (i.e. the breading typically applied to food items to be fried) may rub off of or fall off of the food as it enters the oil within the vat. This may be due to mechanical abrasion between the food and the surfaces of the conveyor, other objects within the vat, or with the oil itself. This may also occur when excess crumbs or breading rests upon the food item, such that when the food enters the oil or falls onto the conveyor the excess crumbs or breading falls off of the food, but sufficient breading remains upon the food to allow it to be effectively fried.

The crumbs or breading Y (or other foreign objects that have a tendency to float within oil-collectively referred to herein as crumbs/breading for the sake of brevity) that enter into the oil tend to float upon the top surface of the oil, and move within the oil as the oil flows within the vat. The crumbs or breading often sticks together as it comes into contact with other wetted crumbs or breading, causing the size of the pieces to increase with operation. It is often desired or important to remove excess crumbs or breading from hot oil for several reasons. Initially, excess crumbs or other foreign material that are floating in hot oil for extended periods of time may cook and then become burned-which is known to reduce the quality of cooking oil (which requires more frequent filtering and may reduce the effective life of the cooking oil) and if the burned crumbs within the oil become fixed to the food being cooked can affect the taste of the food product or the look of the food being cooked. Further, excess crumbs within the oil can come to rest upon walls of the vat and the surfaces of the items within the vat (such as the conveyor 60) which may foul the surfaces, which may affect (typically lower) heat transfer within the system, and may cause other problems with the components within the vat.

Further, as oil flows within the vat, the crumbs Y within the oil have a tendency to flow toward the walls of the vat 20 such as the wall(s) that supports and have a transition to the overflow plenum 100. Accordingly, as the oil flows over the transition and over the top edge 102a has a tendency to include a high volume of crumbs or breading floating thereon.

The overflow plenum 100 is therefore provided to allow for oil to flow therein (FIG. 2, S, schematic), which along with the oil will receive a significant portion of the crumbs/breading that falls into the oil during operations over time, particularly because the crumbs are less likely to flow back into the vat from the overflow plenum 100 due to the construction of the overflow plenum 100. Therefore the crumbs/breading remains within the overflow plenum and the oil that does return to the vat 20 has a tendency to return to the vat without a substantial amount of crumbs with the oil.

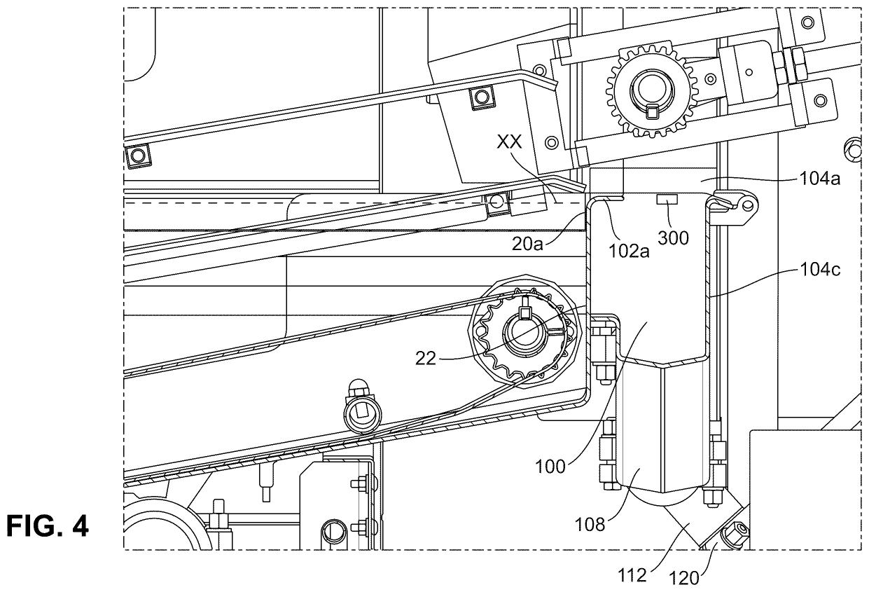

The overflow plenum 100 is best shown in FIGS. 4-6. The front wall 102 may be sized and shaped to mate with surface-to-surface contact (at least at a region proximate to the upper edge 102a) with the vat 20 to provide rigidity and mechanical support to the overflow plenum 100. The side wall 104 may be left and right side walls and a rear wall. These right, left, and rear walls may be continuous portions of the side wall that extend in these general directions with respect to the front wall 102. In some embodiments, the right and left walls and the rear wall may be discrete walls that connect together at edges between the adjacent walls. The side wall portions (i.e. right, left, rear) may be planar or they may be curved. A bottom wall 108 forms a bottom surface of the overflow plenum 100 and the bottom wall is fixed with the front wall 102 and the side wall 104. The combination of the front wall 102, side wall 104, and the bottom wall 108 define an oil volume for holding the oil that flows therein.

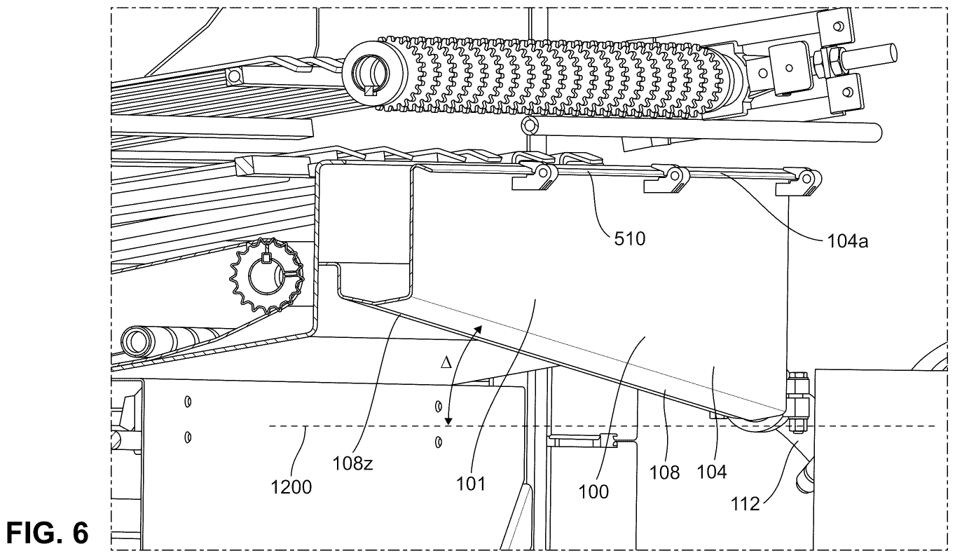

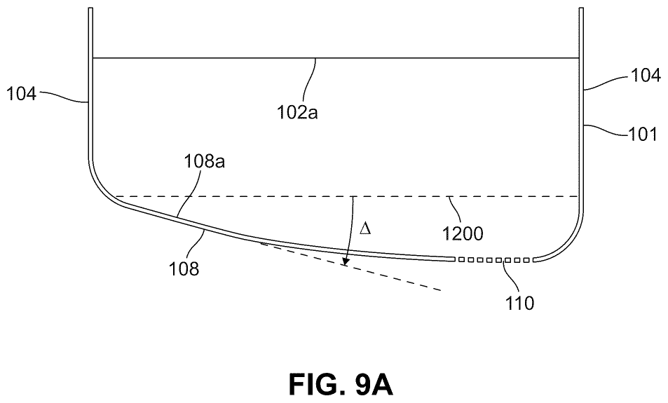

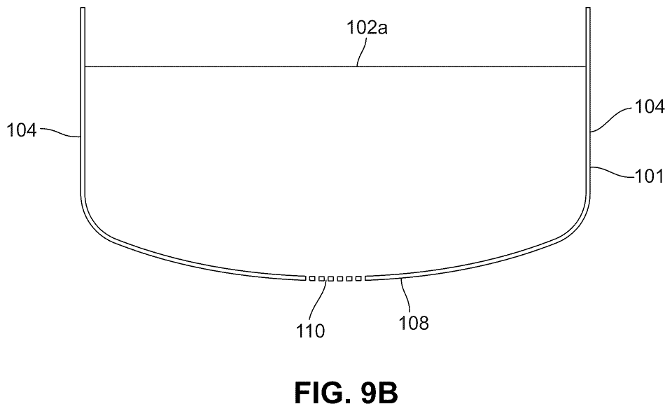

In some embodiments as depicted in FIG. 9a, the bottom surface 108 of the overflow plenum 100 extends at an acute angle Δ with respect to a surface (1200—parallel line to the surface that the system rests upon) that the assembly rests upon, such that one side of the bottom wall (i.e. either the right side or the left side) is at a lower height than the opposite side. In another embodiment in FIG. 9b, the bottom surface 108 is formed wherein a central portion, either an exact center or a portion that is between the left and side sides and spaced from both of the left and right sides, is disposed at a lower position than a remainder of the bottom surface 108. The bottom surface 108 may be curved along its entire surface, may have a portion that is curved with remaining portions being planar, or may be totally planar (but at the acute angle with respect to the floor that the machine rests upon—such that the entirety of the bottom surface is at the acute angle). As depicted in FIG. 6, the angle that the bottom surface makes along it length may be an acute angle Δ with respect to the floor (1200 is parallel to the floor) but the bottom surface may be formed of two intersecting planar portions to form a low center along 108z along the length of the bottom surface 108. The overflow plenum 100 may be constructed with discrete edges (that make interior corners) between adjacent portions—i.e. edges between the front wall 102 and the bottom surface 108, between the front wall 102 and the side wall 104, and between the side wall 104 and the bottom surface 108. These discrete edges may be formed as a corner—i.e. where the two intersecting walls transition to each other at a clean edge, or they may be rounded or form a fillet as the two surfaces meet each other.

One of the bottom surface 108, or the side wall 104 includes one or more apertures 110 (fluid connections) disposed therein that allow (when not blocked) oil to flow out of the overflow plenum 100 and to an external system to filter or otherwise process the oil. The drawings and the specification below depict and describe a single aperture 110 although one of ordinary skill in the art will understand that multiple apertures can be provided within the overflow plenum 100, with those apertures 110 leading to the same place or different places. The oil flows out of the aperture(s) 110 and in some embodiments into a filtration system, which is discussed below.

In some embodiments, the aperture 110 is provided upon the bottom surface 108, and at or closely proximate to a specific low point 108a or low portion within the bottom wall 108 such that all oil within the overflow plenum tends to flow to the aperture 110 due to gravity (and due to static oil pressure within the overflow plenum), i.e. the oil that is within a fluid layer that contacts the bottom surface (or a fluid layer close to the bottom surface will flow along the bottom surface 108 to reach the aperture 110, to allow the oil to completely drain from the overflow plenum 100 when the valve 120 (discussed below) is open for a sufficient amount of time to allow draining. The term “completely drain” is defined herein to mean that all of the oil within the overflow plenum will drain through the aperture other than possibly some oil that remains fixed to one or more walls or bottom surface that forms the overflow plenum—as residual oil in some circumstances tends to do.

In other embodiments the aperture 110 may be provided upon the side wall 104 of the overflow plenum 100 and at a position that is vertically lower than a nominal top surface XX of the oil within the vat 20. Preferably, the aperture is located at a position that is closely proximate to bottom edge of the sidewall 104 and preferably closely proximate to the location upon the specific low point 108a of the bottom wall—to maximize the amount of oil that is vertically above the aperture 110 to maximize the static pressure of the oil above the aperture 110 during normal operations to increase the speed that the oil will drain from the overflow plenum 100 when the valve is open. In this embodiment the aperture 110 may be located upon the side wall with a space 104 between the aperture 110 and the edge between the side wall 104 and the bottom wall 108, such that a portion of the side wall 104 extends between the aperture 110 and the bottom wall 108. In embodiments where an aperture 110 is positioned upon the side wall 104, the aperture is upon the side wall 104 at a position above where the side wall 104 connects to the bottom wall 108 where the bottom wall 108 is at its vertically lowest position (or proximate to the position of the vertically lowest height such as where the vertically lowest height of the bottom wall is a funnel or cone shape, with a portion that forms the funnel or cone shape close to or intersecting the edge between the side wall 104 and the bottom wall 108 below the aperture 110. In some embodiments, apertures are positioned both upon the side wall 104 and the bottom wall 108 and are opened and closed simultaneously, or with the side wall aperture opened slightly before the bottom wall aperture and the bottom wall aperture closed after the side wall aperture is closed. The two apertures (that are operated by two valves 120 (discussed below) may result in faster complete draining of the oil within the overflow plenum 100 when the valves 120 are initially opened, and therefore less oil that is within the vat 20 when the valves 120 are opened flowing into the overflow plenum after the valves are open, which would cause the oil level within the vat to decrease more than desired during cooking operations within the vat 20.

In some embodiments, a valve 120 is provided downstream of the aperture 110, preferably proximate to the aperture 110 to minimize the length of piping between the aperture 110 and the valve 120. The valve 120 may be a remotely operated valve, such as a solenoid valve, to allow a controller 1000 (FIG. 1, schematic) to control the position of the valve 120.

The valve 120 includes a closed position that prevents flow out of the overflow plenum 100 through the aperture 110 that is associated with the valve 120 and an open position that allows to allow flow of oil therethrough (and foreign material that is within the oil and resting/floating upon the oil) from the overflow plenum 100. The valve 120 may be a remotely operated valve that can switch positions (and maintain a current position) based upon the receipt of signals with instructions to change positions (i.e. open to shut or shut to open) or to maintain a current position. The signals may be provided from a controller 1000 (schematic) that is provided to control the operation of the valve 120. The controller 1000 may be a dedicated controller for the valve 120 and preferably the controller 1000 may control the operation of the other aspects of the vat—such as operation of the conveyors 60, control of the oil temperature within the vat 20, the control of adding make up oil when needed, and other controlled parameters.

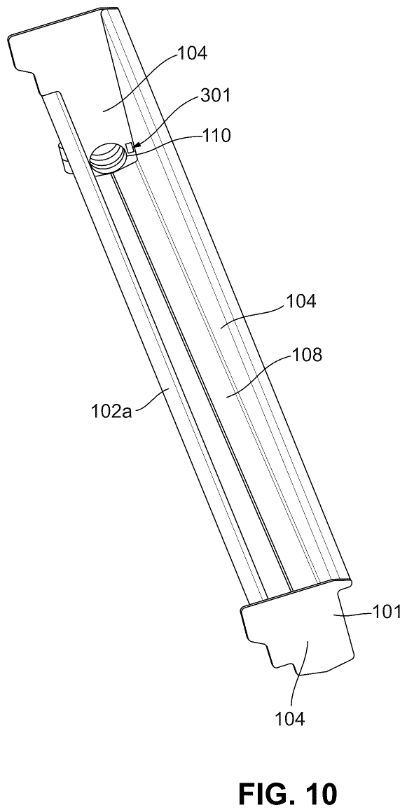

The controller 1000 may control the valve 120 (or the valve may directly control itself) based upon one or more different strategies. In one embodiment, the valve 120 may be controlled to open and shut with a set duty cycle, based upon a timer that operates during cooking operations of the vat 20. For example, while the vat 20 is receiving and cooking food the valve 120 may be opened periodically during the operation. When open, the valve 120 may remain open for a sufficient period of time for the oil that is within the overflow plenum at the time when the valve 120 opens to flow through the aperture 110 and flow through the valve 120 and shut shortly or immediately after that time to minimize the amount of oil from the vat that flows into the overflow plenum 100 while the valve 120 is open to limit the amount of immediate draining of the oil from the vat 20 through the valve 120. When the valve 120 shuts oil is prevented from freely flowing through the aperture 110 (other than a small amount of oil that can flow through the aperture 110 to file a length of piping between the aperture 110 and the valve 120 when the valve is shut. In some embodiments, the valve 120 may be maintained open for a set period of time that is representative of a experimentally determined amount of time to fully drain the oil that is within the overflow plenum 100 when the valve 120 opens—but to shut after that experimentally determined time so to not be maintained open to allow oil from the vat 20 to flow into the overflow plenum 100 (which would cause the oil to drain through the aperture 110 directly from the vat 20). Alternatively, an oil level sensor 301 (FIG. 10, schematic) to sense oil level proximate to the bottom surface 108 and may cause the valve 120 to shut when a top surface of the oil within the overflow plenum 100 reaches the height of the sensor 301.

The duty cycle of the valve 120—i.e. the typical delay time between a time when the valve 120 shuts and when it opens again during operations of the vat 20 may vary and can be determined by one of ordinary skill in the art with a thorough review of this specification and testing or observation of the typical amount of crumbs/breading that enters into the vat during operations of the frying system—which may differ based upon different types of foods that are cooked in the vat—and based upon different recipes (e.g. type of covering of the food that is cooked within the vat, the amount of type that the food remains in the vat while cooking, the temperature of the oil, and other factors). The amount of crumbs/breading that become entrained with the oil in the vat 20 per time period can be experimentally determined by one of ordinary skill in the art with only routine observation and testing.

It may be determined based upon the observation and testing discussed above that during normal cooking operations without any removal of crumbs/breading from the oil that the increased presence of crumbs/breading within the oil over a specific time with continued operation may become problematic for various reasons as discussed herein (e.g. the crumbs/breading being themselves cooked within the hot oil and degrade the quality of the oil or if imparted upon food being cooked degrade the quality of the food being cooked, foul mechanical surfaces or mechanisms within the vat, etc.), with potentially differing times for different foods being foods within the vat, different types of coatings applied to the food that is cooked within the vat, different temperatures of the oil, etc. The specific time may be readily determined with testing and without undue experimentation.

In some embodiments, the duty cycle of the valve 120 may be set to a period of time (i.e. time between when the valve 120 shuts until when it reopens) that is less than the specific time determined for the food being cooked (and the specific coating of the food being cooked, cooking recipe, operation of the vat, etc.) in order to oil from the overflow plenum 100 once or multiple times per specific time period—to prevent the accumulation of crumbs/breading within the oil within the vat. For example, if it experimentally determined that the specific time is 1 hour of continuous frying operations, then the valve may be cycled open and closed (to drain the overflow plenum 100 with each cycle) once, twice, or three times (or even more times) during that one hour.

As discussed herein, the oil that flows through the valve 120 may flow to a filtration system (200, schematic) that is configured to receive a batch of oil and filter that oil—for various purposes and then allow for the return of the oil to the vat 20—typically by being pumped from the filtering system 200 to the vat 20. The filtration system 200 is configured to mechanically remove crumbs/breading and other impurities from the oil, such that the oil that exits the filtration system 200 can be returned to the vat 20. The filtration system 200 will have a known operational time—i.e. the time from receipt of a batch of oil (such as a batch that is slightly larger than the volume of the overflow plenum 100) for the filtration system 200 to operate to remove the crumbs/breading and other impurities of the oil such that the oil can be returned to the vat. As can be understood, the duty cycle of the valve 120 will be greater than the known operational time of the filtration system 200 to avoid a back-up of oil that has flowed from the overflow plenum 100 but awaits to flow into the filtration system 200.

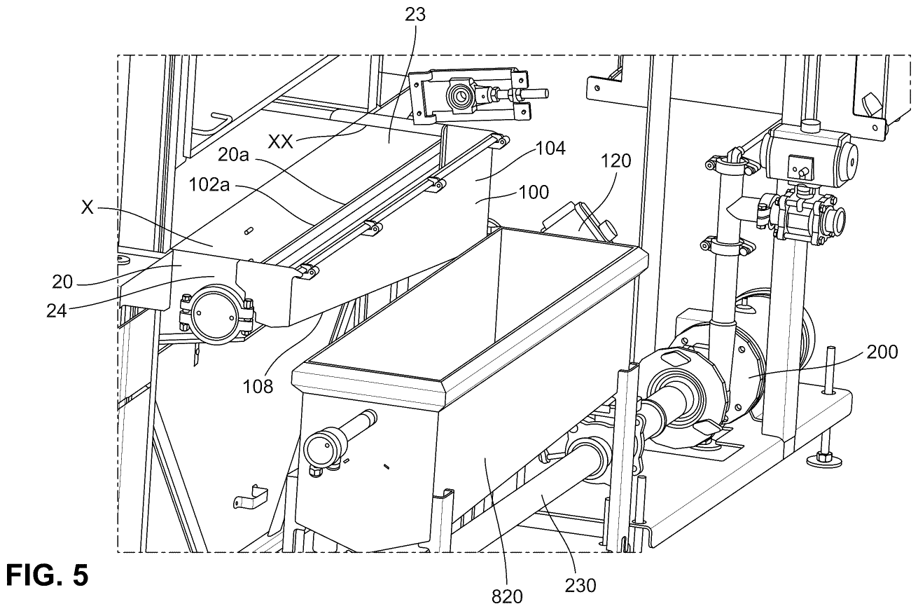

In some embodiments, the filtration system 200 may include a holding tank 820—as depicted in FIG. 5. The holding tank 820 may receive the flow of oil and entrained crumbs that flows through the valve 120. The holding tank 820 may hold the oil therein until the filtration system 200 is ready to receive the oil to be filtered as discussed herein.

As depicted in the figures, the holding tank 820 is connected to the overflow plenum 100 that is fixed to the rear wall of the vat 20. In embodiments where multiple overflow plenums are provided at different locations of the vat 20, some or all of the overflow plenums may be plumbed (and controller by valves similar to valve 120, and with pumps therebetween if necessary or desired) to allow flow from the various overflow plenums to sequentially be drained (as controlled by the respective associated valves 120) with the drained oil/crumbs flowing into the same holding tank 820 for all or some of the overflow plenums. The oil/crumbs from the holding tank 820 then may flow to the filtration system 200 (regardless of from which overflow plenum the oil flowed into the holding tank 820), and after being filtered that oil can return to the vat 20 as discussed herein. The use of a single holding tank 820 that receives oil from all (or some) of the overflow plenums provides a reduction in the number of components needed with the system and a reduction of the footprint of the system 10.

In some embodiments, the holding tank 820 is sized to receive a volume of oil that is the same as one volume of oil that is received within an overflow plenum 100. The system 10 in this circumstance is configured to allow for the draining of an overflow plenum (via operation of the valve 120) only when the holding tank 820 is empty (not withstanding any minimal oil/crumbs that remained within the holding tank 820 after the holding tank 820 is drained), to prevent multiple cycles of draining the overflow plenum(s) with that drained oil remaining out of the vat for multiple cycles—which may cause the oil level in the vat 20 to lower more than desired or required for normal cooking operations within the vat 20. In other words—because in this embodiment the holding tank 820 can only receive one volume of oil from an overflow plenum, the amount of oil outside of the vat 20 for processing (which could equal two volumes of oil from the overflow plenum—a first volume being filtered by the filtration system 200 and being returned when the filtration is complete, and a second volume stored within the holding tank 820 waiting for the current filtration cycle to be completed and that oil returned to the vat 20 before the oil within the holding tank 820 is then filtered within the filtration system. This arrangement allows for maintaining the oil level within the vat 20 within a tight band (i.e. oil level XX plus or minus an appropriate tolerance) with the existence of one or more overflow plenums, and reduces the need for excess oil to be provided within the system 10 (such as if more than two volumes of oil from overflow plenum cycles could be maintained outside of the vat 20 at any given time) thereby reducing the operational cost of avoiding the need for providing much more oil than is necessary to maintain the heated oil volume at the desired level within the vat for cooking. This arrangement also minimizes the amount of oil that is outside of the vat 20 (and associated overflow plenum(s) 100) at any given time (in this embodiment at most 2 volumes at any given time) to minimize the amount of oil that is not receiving heat from the vat—that would need to be heated when returned to the vat 20 (which could cause undesireable oil temperature transients such is several volumes of cooled oil is returned to the vat at one time)—or would need to be heated outside of the vat 20—which often requires more energy than the energy used to heat the oil within the vat 20.

As depicted in the figures, the holding tank 820 may be positioned next to the vat 20 and below an outlet conveyor 60 such that crumbs from the operation of the conveyors may fall into the holding tank 820 and residual oil that drips from the food leaving the vat via the conveyor may drip into the holding tank 820 for oil recovery purposes.

In some embodiments, the filtration system 200, either during the filtration process, or after the filtration process may apply heat to the oil to return the oil to or toward the desired oil temperature within the vat 20 such that a bulk return of oil to the vat 20 after the filtration process is complete does not cause a significant temperature drop in the bulk (or localized) oil temperature within the vat 20 to require a delay in cooking process or to effect that quality of food being cooked within the vat just after the oil is bulk returned to the vat 20. The oil may return to the vat 20 via a single return pipe or it may return to the vat 20 two or more return pipes to avoid all of the oil returning at a single position within the vat 20 (which may have a temperature transient due the returning oil at that the localized return position within the vat—and/or may cause currents of flow within the oil within the vat at the localized position).

In some embodiments, the timing of the valve 120 duty cycle may operate in concert with the timing of the completion of a filtration cycle of the filtration system 200, such that just filtered oil is returned to the vat 20 at the same time (or just after) the valve 120 opened to cause flow of the oil within the overflow plenum 100 through the valve 120 and toward the filtration system 200. This timing (as controlled by the controller 1000, or multiple controllers that are in communication with each other) causes the level of the vat 20 to increase as the oil is returned to the vat 20 so that the oil level XX within the vat is at the normal level or preferably just above the oil level XX so that oil flows from the vat 20 and over the top edge 102a of the transition and into the overflow plenum 100 after the valve 120 closes to allow the overflow plenum 100 to begin refilling with oil from the vat 20 and, as discussed herein, causing crumbs/breading within the oil proximate to the transition to flow into the overflow plenum 100.

In some embodiments, the vat 20 may have one or more systems that urge oil proximate to the top surface of the oil within the vat 20 to flow toward the overflow plenum 100. The system may be a pump that directs pressurized oil in a direction toward the overflow plenum, a fan that directs air above the oil in a direction toward the overflow plenum 100, or other structure. In some embodiments, the conveyor system 60 may be arranged and operated such that a oil current is created as the conveyor system operates to urge oil toward the overflow plenum 100. The system may particularly operate to urge crumbs/breading that is flowing at the top surface of the oil to flow toward the overflow plenum 100. As discussed, the oil level within the vat 20 is at or just above the top edge 102a of the front wall 102 such that oil (including crumbs/breading) that is directed toward the overflow plenum 100 flows over the top edge and into the overflow plenum 100—to concentrate upon causing the floating items to flow into the overflow plenum 100.

In some embodiments, the piping 112 from the aperture 110 and through the valve 120 may be arranged to be sloping downward (including with one or more vertical portions, including entirely vertical downward) such that the force of gravity urges oil (including the static pressure of oil within the overflow plenum 100) flow through from the overflow plenum 100, through the aperture 110, through the valve 120, and toward or to the filtration system 200. In some embodiments, a suction system, such as a suction pump 210 (FIG. 2, schematic) may be provided within the piping downstream of the valve 120 to enhance the flow of oil from the overflow plenum 100 when operating to increase the oil flow rate through the aperture 110 and the valve 120 to minimize the time that the valve 120 needs to be open to cause the oil within the overflow plenum 100 to flow out through the aperture 110—and thereby minimize the amount of oil that flows out of the vat 20 and directly through the aperture 110 when the valve 120 is open. The suction system urges oil flow from the overflow plenum and through the aperture 110 and valve 120 and toward the suction system at a faster rate than oil would flow through the aperture and valve based solely due to the force of gravity and the accumulated static pressure of oil within the overflow plenum 100 above the aperture 110 and the valve 120. The suction pump 210, when provided, is operated by the controller 1000 or in conjunction with the controller(s) 1000 that operate that valve 120 and the filtration system 200 such that these components operate in an appropriate sequence (i.e. the suction pump 210 operates when the valve 120 is open, and the filtration system 200 is ready to receive a batch of oil to be filtered.

In some embodiments, a pump 220 (FIG. 2, schematic) is provided to pump oil that flows through the valve 120 to the filtration system 200, where the pump 200 takes suction from oil flowing through the valve 120 and discharges the oil toward the filtration system 200. The pump 220 is operated by a controller 1000 that is the same controller that operates the valve 120 or is in communication with the controller that operates the valve 120 so that the pump and the valve can be operated in conjunction with each other.

In some embodiments, a sensor 300 (FIG. 4) may be provided that observes the existence, or the concentration, of foreign materials (such as crumbs/breading) entrained and floating within the oil that is in the overflow plenum 100.

The sensor 300 may be capable of identifying foreign material within oil with respect to a specific amount of foreign material per monitored volume of oil. The sensor 300 may provide a signal that is proportional to the amount of foreign material within the oil with the controller 1000 receiving the signal and identifying whether the magnitude of the signal meets or exceeds a threshold of allowable concentration of foreign material within the oil Alternatively, the sensor may send a signal every time that it detects the presence of foreign material within the oil that is greater than or equal to a certain size, and the controller upon receiving the signals from the sensor 300 determines whether a specific number of signals for a given time period are received. The sensor may be a vison sensor (laser line), acoustic, proximity, or other types of sensors that can monitor the existence of foreign material within oil.

The sensor 300 may be in communication with the controller 1000 to provide a signal to the controller that a predetermined concentration of foreign materials is present within the vat 20. Alternatively, the sensor may communicate a signal that is proportional to the observed presence of a concentration of foreign materials within the oil—and the controller is programmed to determine when the predetermined concentration of foreign materials is present within the oil within the overflow plenum 100. When the observed concentration of foreign materials (based upon the sensor's signal as discussed above) exceeds the predetermined maximum concentration the controller 1000 determines whether the filtration system 200 is capable of accepting a batch of oil from the overflow plenum, and if the filtration system 200 is capable of accepting the batch of oil, the controller 1000 causes the valve 120 to open (and the suction pump 210 to operate if provided). If the controller 1000 determines that the filtration system 2000 is not capable of accepting the batch of oil, the controller 1000 awaits to cause the valve 120 to open until the filtration system 200 is capable of receiving the next batch of oil.

In embodiments with the sensor 300 and where the valve 120 is operated based upon a timed sequence or delay from the last operation as discussed above, the controller 1000 may cause the valve 120 to open (based upon the observed concentration of foreign materials by the sensor exceed the predetermined maximum concentration) at a time before the expiration of the timed sequence-assuming that the filtration system 200 at that time is capable of receipt of a new batch of oil. In this instance, the controller may reset the timer in the same manner that the timer is reset when a valve opening cycle occurs based upon the normal elapse of the timer.

In some embodiments the filtration system 200 receives oil from the valve 120 and is configured to batch filter or continuously filter the oil that is received.

The filtration system 200 may be any type of filtration system that is known in the art for receipt of cooking oil and for the removal of impurities (including crumbs) from cooking oil. The filtration system 200 may include one or more screens that the oil flows therethrough as well as a grinder for receipt and removal of crumbs and other particulate impurities from oil. The filtration system 200 may include one or more pumps to force oil through the various screens and grinders. The filtration system may include a receipt plenum for filtered oil to be held until the entirety of the oil received is filtered to allow the oil to be returned to the vat in a bulk pumping action. Alternatively, the filtration system may be set up to continuously return oil to the vat after it is filtered.

In some embodiments, an oil transport system 500 is provided. The oil transport system 500 may be operated by the controller 1000 (either the same controller as operates other components of the system 10 discussed herein, or in communication with the other controllers discussed herein). The oil transport system 500 may be operated to periodically allow oil flow from the vat 20 and into the overflow plenum, such as based upon a timer for sequentially timed operation, or to periodically allow oil flow from the vat 20 into the overflow plenum 100 when it is determined that it is needed—such as upon signals provided by oil quality sensors 300 (or foreign particle sensors) within the vat. Alternatively, the controller 1000 that operates overall frying system may identify that the oil transport system 500 should operate to allow oil to flow into the overflow plenum 100 after a certain amount of food is cooked within the vat 20 during a timed sequence. Still alternatively, the oil transport system 500 may operate in sequence or in order with a return of filtered oil to the vat 20 from the filtration system 200 (discussed herein) such that the nominal oil level XX can be maintained as consistent as possible when oil is bulk returned to the vat 20 from the filtration system 200.

The oil transport system 500 is operable to be repositioned to either allow oil to flow from the vat 20 to the overflow plenum 100, such that for example, when the oil transport system is in the first position oil is prevented from flowing from the vat into the overflow plenum 100, and in the second position oil is allowed to flow into the overflow plenum. In one embodiment, the oil transport system 500 is a door 510 that is mounted with respect to the front wall 102 of the overflow plenum (and may be specifically mounted upon the neighboring sidewall of the vat 20, the front wall 102 of the overflow plenum, other structure of the overflow plenum 100, or a combination of structures of the vat 20 and the overflow plenum 100. The door 510 may be upright in the first position and provide a functional wall within the vat that is higher than the nominal oil level XX (and in some embodiments the highest oil level during normal operations) to block oil from flowing over the top edge 102a of the front wall 102 of the overflow plenum and into the overflow plenum. In a second position, the door 510 may be rotated to lay flat (or at an orientation) to allow flow from the vat 20 and into the overflow plenum 100 over the top edge 102a.

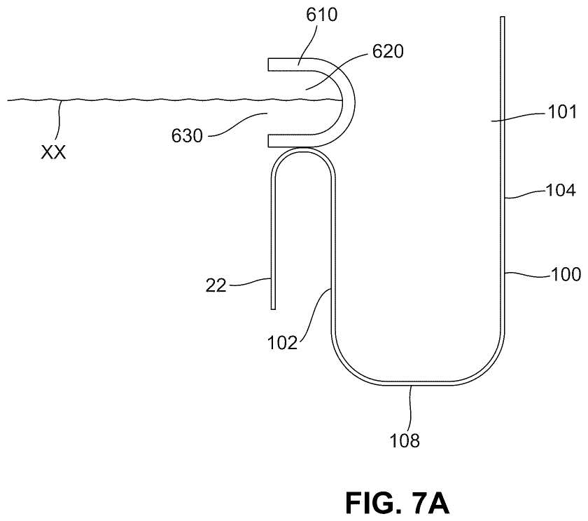

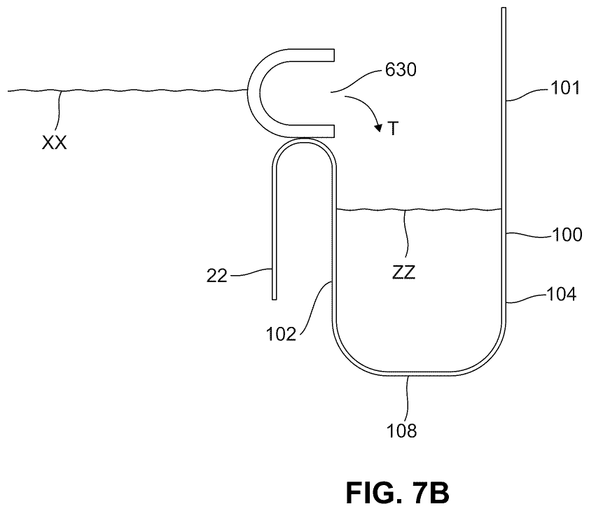

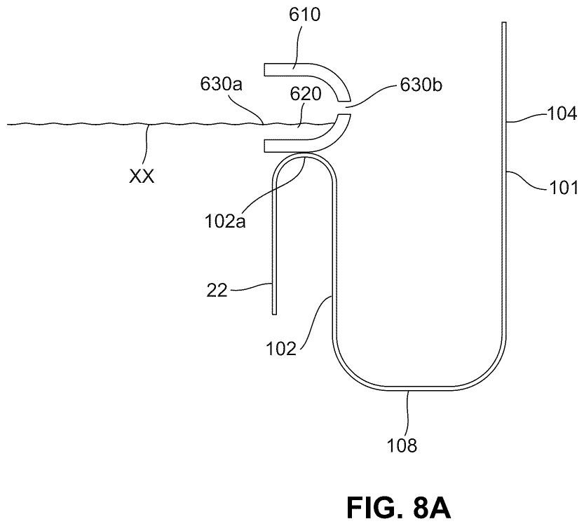

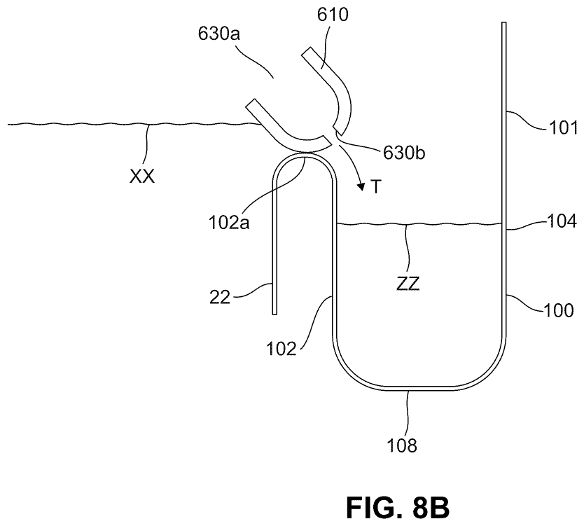

In another embodiment depicted in FIGS. 7a-8b, the oil transport system 500 is a movable container 610 that includes an oil receipt volume 620. In the first position (FIG. 7a, 8a), the container 610 receives oil from the vat 20 within the receipt volume and maintains the oil within the receipt volume 620. The oil is received through an aperture 630. When in the second position (FIG. 7b, 8b), the container is rotated, or otherwise moved, such that the oil the container is positioned such that the oil drains (T) from the receipt volume through the aperture 630 and into the overflow plenum 100. The container 610 may have a single aperture 630 (FIGS. 7a, 7b) to allow oil to enter the receipt volume and to allow oil to flow from the receipt volume, or alternatively, the container may have dedicated apertures for inlet and outlet (630a, 630b)—FIGS. 7a, 7b, with only one aperture being positioned to allow oil to flow therethrough depending upon the position of the container 610. The oil receipt volume 620 may be a faction of the volume of the overflow plenum 100 such that the movable container must move between first and second positions multiple times for the overflow plenum to fill with oil. Alternatively, the oil receipt volume 620 may be the same volume as the overflow plenum—which allows for oil level management within the vat 20 to maintain oil within the vat at the nominal height XX when oil flows into the vat 20 (either via replacement oil or by oil returning from the filtration system 200) during cooking operations.

The overflow plenum 100 may be operated in conjunction with an oil refill system 230 (schematic) that is operated by a controller 1000 of the vat to add replacement oil periodically to maintain the oil level at the nominal level XX during cooking operations. As well understood, during a frying process some oil is soaked into the food that is cooked, which will remove a small amount of oil from the vat 20 with each food that is cooked. The oil refill system 230 may operate in conjunction with the filtration system 200 discussed herein or as a separate system.

The term “about” is specifically defined herein to include a range that includes the reference value and plus or minus 5% of the reference value. The term “substantially the same” is satisfied when the width of the end surfaces of the holes are both within the above range.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The specification can be readily understood with reference to the following Numbered Paragraphs:
Numbered Paragraph 1: A system to remove foreign matter from cooking oil, comprising:
   a vat that receives a volume of heated oil for cooking food products therein, the oil establishes a nominal top oil surface during heated cooking operations within the vat, the vat supporting a conveyor system that causes movement of a food product from an inlet end to an exit end of the vat, the vat is configured to receive the volume of heated oil such that the nominal top oil surface is above at least a portion of the conveyor system, a sidewall of the vat extends vertically above the nominal top surface of the oil, the sidewall includes an entry portion, right and left side portions, and an exit portion, wherein the entry portion is proximate to a position where the food product initially enters into the vat and onto the conveyor system, and the exit portion is proximate to a different position where the food product exits the vat after reaching an opposite end of the conveyor system;
   an overflow plenum that is in fluid communication with the volume of heated oil, the overflow plenum is fixed to the vat such that a transition from the vat to the overflow plenum is at a height that is vertically lower than the nominal top surface of the oil within the vat to allow oil to flow from the vat and into the overflow plenum;
   the overflow plenum includes bottom surface, at least one side surface, and an overflow surface that is fixed to a sidewall of the vat;
   the vat at the location of the transition from the vat to the overflow plenum includes a top edge of the respective sidewall that is at the same height as or is slightly lower than the height of the nominal top surface of the oil.
Numbered Paragraph 2: The system to remove foreign matter from cooking oil of Numbered Paragraph 1, wherein at least a portion of the bottom surface of the overflow plenum is disposed at an acute angle with respect to a floor surface that the vat rests upon.
Numbered Paragraph 3: The system to remove foreign matter from cooling oil of Numbered Paragraph 2, wherein the entirety of the bottom surface of the overflow plenum is disposed at the acute angle with respect to the floor surface that the vat rests upon.
Numbered Paragraph 4: The system to remove foreign matter from cooking oil of any one of Numbered Paragraphs 1-3, further comprising a fluid connection to an external system to filter or otherwise process oil, wherein the fluid connection is disposed within the overflow plenum.
Numbered Paragraph 5: The system to remove foreign matter from cooking oil of Numbered Paragraph 4, wherein the fluid connection is disposed vertically lower than the top surface of the oil within the overflow plenum.
Numbered Paragraph 6: The system to remove foreign matter from cooking oil of Numbered Paragraph 5, wherein the bottom surface of the overflow plenum is disposed below the fluid connection, and wherein the fluid connection is disposed through the side surface of the vat.
Numbered Paragraph 7: The system to remove foreign matter from cooking oil of Numbered Paragraph 5, wherein a vertically lowest portion of the bottom surface transitions to the side wall surface directly below the fluid connection.
Numbered Paragraph 8: The system to remove foreign matter from cooking oil of any one of Numbered Paragraphs 4-7, further comprising a valve positioned proximate to the fluid connection, such that when the valve is closed oil from the overflow plenum does not flow through a pipe that extends from the fluid connection, and when the valve is opened oil flows from the pipe.
Numbered Paragraph 9: The system to remove foreign matter from cooking oil of Numbered Paragraph 8, wherein the valve is remotely operable such that the valve opens upon receipt of a signal indicative of a command to open the valve.
Numbered Paragraph 10: The system to remove foreign matter from cooking oil of Numbered Paragraph 9, wherein the valve upon receipt of the signal indicative of the command to open the valve remains open for a fixed period of time.
Numbered Paragraph 11: The system to remove foreign matter from cooking oil of Numbered Paragraph 9, wherein the signal is generated from a timer within a controller such that the signal is generated at a predetermined frequency during operation of the fryer.
Numbered Paragraph 12: The system to remove foreign matter from cooking oil of Numbered Paragraph 9, further comprising a sensor disposed with respect to the overflow plenum in order to observe an existence of foreign materials entrained within the oil within the overflow plenum, wherein the sensor is capable of identifying of foreign material entrained within the oil within the overflow plenum with respect to a specific amount of foreign material per monitored volume of oil, wherein the sensor upon identification of the respective presence foreign material entrained within the oil at or a above a certain concentration causes a signal to be sent to the valve indicative of the command to open the valve.
Numbered Paragraph 13: The system to remove foreign matter from cooking oil of Numbered Paragraph 12, wherein the valve automatically closes when either it is determined that all oil has drained from the overflow plenum or it is observed that an oil level within the overflow plenum has reached a position proximate to the bottom surface of the overflow plenum.
Numbered Paragraph 14: The system to remove foreign matter from cooking oil of Numbered Paragraph 13, wherein a timer is initiated when the valve is initially opened and the valve is shut when the timer reaches an elapsed time that is representative of a determined time for the oil within a full overflow plenum to completely drain from the overflow plenum through the aperture.
Numbered Paragraph 15: The system to remove foreign matter from cooking oil of any one of Numbered Paragraphs 8-14, further comprising a suction system disposed within a fluid pipe downstream of the valve, wherein when the valve is open and the suction system is operating oil is urged through the fluid connection due to both the operation of the suction system and the accumulated static pressure of the oil within the overflow plenum above a position of the fluid connection.
Numbered Paragraph 16: The system to remove foreign matter from cooking oil of any one of the Preceding Numbered Paragraphs, wherein the overflow surface is a curved surface that is convex upward.
Numbered Paragraph 17: The system to remove foreign matter from cooking oil of any one of the Preceding Numbered Paragraphs, wherein the top edge of the at least one side surface of the overflow plenum is at a same height or higher than a top edge of the sidewall of the vat.
Numbered Paragraph 18: The system to remove foreign matter from cooking oil of any one of the Preceding Numbered Paragraphs, wherein the overflow plenum is fixed to the vat proximate to the entry portion of the vat.
Numbered Paragraph 19: The system to remove foreign matter from cooking oil of any one of the Preceding Numbered Paragraphs, further comprising an oil transport system that is located proximate to the overflow plenum, wherein the oil transport system causes oil flow within the vat in a direction such that oil proximate to the overflow plenum is urged to enter into the overflow plenum.
Numbered Paragraph 20: The system to remove foreign matter from cooking oil of any one of the Preceding Numbered Paragraphs, wherein the overflow plenum comprises a first overflow plenum that is fixed to the vat proximate to the entry portion of the vat, and a second overflow plenum that is fixed to the vat proximate to the exit portion of the vat.
Numbered Paragraph 21: The system to remove foreign matter from cooking oil of Numbered Paragraph 21, further comprising an exit conveyor proximate to the exit portion of the vat, wherein food exits the vat via the exit conveyor, wherein the exit conveyor extends above the second overflow plenum such that oil dripping from the exit conveyor and the food disposed upon the exit conveyor drips into the second overflow plenum.
Numbered Paragraph 22: The system to remove foreign matter from cooking oil of any one of Numbered Paragraphs 1-20, wherein the overflow plenum is proximate to an exit portion of the vat, further comprising an exit conveyor proximate to the exit portion of the vat, wherein the exit conveyor extends above the overflow plenum such that oil dripping from the exit conveyor and the food disposed upon the exit conveyor drips into the overflow plenum.
Numbered Paragraph 23: The system to remove foreign matter from cooking oil of Numbered Paragraph 19, wherein the oil transport system operates continuously to continuously cause oil flow within the vat toward the overflow plenum.
Numbered Paragraph 24: The system to remove foreign matter from cooking oil of Numbered Paragraph 19, wherein the oil transport system operates periodically to cause oil flow within the vat toward the overflow plenum.
Numbered Paragraph 25: The system to remove foreign matter from cooking oil of Numbered Paragraph 19, wherein the oil transport system is movably fixed with respect to the front wall of the housing, the oil transport system selectively allows or prevents oil flow from the vat to the housing based upon an operation position of the oil transport system.
Numbered Paragraph 26: The system to remove foreign matter from cooking oil of Numbered Paragraph 25, wherein the oil transport system is movably mounted with respect to the front wall of the housing, the oil transport system includes receipt volume and an aperture, the oil transport system can be moved between first and second positions, wherein when in the first position the receipt volume is arranged to receive oil therein that flows into the receipt volume through the aperture, and wherein when in the second position, oil is blocked from entering the receipt volume through the aperture, and oil flows out of the receipt volume through the aperture and into the plenum of the housing.
Numbered Paragraph 27: The system to remove foreign matter from cooking oil of Numbered Paragraph 26, wherein the aperture is a first aperture that receives oil from the vat when the in the first position, and a second aperture that allows flow from the receipt volume to the housing when in the second position.
Numbered Paragraph 28: The system to remove foreign matter from cooking oil of any one of Numbered Paragraphs 26 or 27, wherein a controller provides a signal that causes the oil transport system to move from the first position to the second position and after remaining at the second position for a set time to return the first position.
Numbered Paragraph 29: The system to remove foreign matter from cooking oil of Numbered Paragraph 28, wherein the controller provides the signal based upon a timer, with the controller providing the signal at the expiration of a predetermined elapsed time by the timer, and the controller resets the timer to start a new time sequence a short time after the elapsed time.
Numbered Paragraph 30: The system to remove foreign matter from cooking oil of Numbered Paragraph 25, wherein the oil transport system is a door that is pivotably mounted with respect to the housing, wherein when the door is in a first position, oil is prevented from flowing from a vat to the housing, and when the door is in the second position, oil is allowed to flow from the vat to the housing.
Numbered Paragraph 31: An oil receiving system, comprising:
a housing that includes a front wall, a side wall, and a bottom wall, the front wall being configured to be connectable to an outer edge of a vat, the combined front wall, side wall, and bottom wall form a plenum for receipt of oil therein;
further comprising a fluid connection disposed in either the side wall or the bottom wall, the fluid connection vertically disposed below a top edge of the front wall,
further comprising a piped system that allows flow from within the plenum through the fluid connection;
a valve disposed at or proximate to the fluid connection and operable to either allow flow from the plenum through the fluid connection or prevent flow from the plenum through the fluid connection.
Numbered Paragraph 32: The oil receiving system of Numbered Paragraph 31, further comprising an oil transport system that is movably fixed with respect to the front wall of the housing, the oil transport system selectively allows or prevents oil flow from the vat to the housing based upon an operational position of the oil transport system, wherein a first position prevents flow into the housing and a second position allows flow into the housing.
Numbered Paragraph 33. The oil receiving system of Numbered Paragraph 32, wherein the oil transport system is movably mounted with respect to the front wall, the oil transport system includes receipt volume and an aperture, the oil transport system can be moved between first and second positions, wherein when in the first position the receipt volume is arranged to receive oil therein that flows into the receipt volume through the aperture, and wherein when in the second position, oil is blocked from entering the receipt volume through the aperture, and oil flows out of the receipt volume through the aperture and into the plenum of the housing.
Numbered Paragraph 34. The oil receiving system of Numbered Paragraph 33, wherein the aperture is a first aperture that receives oil from the vat when the in the first position, and a second aperture that allows flow from the receipt volume to the housing when in the second position.
Numbered Paragraph 35: The oil receiving system of Numbered Paragraph 33, wherein a controller provides a signal that causes the oil transport system to move from the first position to the second position and after remaining at the second position for a set time to return the first position.
Numbered Paragraph 36: The oil receiving system of Numbered Paragraph 35, wherein the controller provides the signal based upon a timer, with the controller providing the signal at the expiration of a predetermined elapsed time by the timer, and the controller resets the timer to start a new time sequence a short time after the elapsed time.
Numbered Paragraph 37: The oil receiving system of Numbered Paragraph 32, wherein the oil transport system is a door that is pivotably mounted with respect to the housing, wherein when the door is in a first position, oil is prevented from flowing from a vat to the housing, and when the door is in the second position, oil is allowed to flow from the vat to the housing.

1. A system to remove foreign matter from cooking oil, comprising:
a vat that receives a volume of heated oil for cooking food products therein, the oil establishes a nominal top oil surface during heated cooking operations within the vat, the vat supporting a conveyor system that causes movement of a food product from an inlet end to an exit end of the vat, the vat is configured to receive the volume of heated oil such that the nominal top oil surface is above at least a portion of the conveyor system, a sidewall of the vat extends vertically above the nominal top surface of the oil, the sidewall includes an entry portion, right and left side portions, and an exit portion, wherein the entry portion is proximate to a position where the food product initially enters into the vat and onto the conveyor system, and the exit portion is proximate to a different position where the food product exits the vat after reaching an opposite end of the conveyor system;
an overflow plenum that is in fluid communication with the volume of heated oil, the overflow plenum is fixed to the vat such that a transition from the vat to the overflow plenum is at a height that is vertically lower than the nominal top surface of the oil within the vat to allow oil to flow from the vat and into the overflow plenum;
the overflow plenum includes a housing that includes a front wall, a bottom surface, at least one side surface, and an overflow surface that is fixed to a sidewall of the vat;
the vat at the location of the transition from the vat to the overflow plenum includes a top edge of the respective sidewall that is at the same height as or is slightly lower than the height of the nominal top surface of the oil.

2. The system to remove foreign matter from cooking oil of claim 1, wherein at least a portion of the bottom surface of the overflow plenum is disposed at an acute angle with respect to a floor surface that the vat rests upon.

3. The system to remove foreign matter from cooling oil of claim 2, wherein the entirety of the bottom surface of the overflow plenum is disposed at the acute angle with respect to the floor surface that the vat rests upon.

4. The system to remove foreign matter from cooking oil of claim 1, further comprising a fluid connection to an external system to filter or otherwise process oil, wherein the fluid connection is disposed within the overflow plenum.

5. The system to remove foreign matter from cooking oil of claim 4, wherein the bottom surface of the overflow plenum is disposed below the fluid connection, and wherein the fluid connection is disposed through the side surface of the vat.

6. The system to remove foreign matter from cooking oil of claim 5, wherein a vertically lowest portion of the bottom surface transitions to the side wall surface directly below the fluid connection.

7. The system to remove foreign matter from cooking oil of claim 4, further comprising a valve positioned proximate to the fluid connection, such that when the valve is closed oil from the overflow plenum does not flow through a pipe that extends from the fluid connection, and when the valve is opened oil flows from the pipe.

8. The system to remove foreign matter from cooking oil of claim 7, wherein the valve is remotely operable such that the valve opens upon receipt of a signal indicative of a command to open the valve.

9. The system to remove foreign matter from cooking oil of claim 8, further comprising a sensor disposed with respect to the overflow plenum in order to observe an existence of foreign materials entrained within the oil within the overflow plenum, wherein the sensor is capable of identifying of foreign material entrained within the oil within the overflow plenum with respect to a specific amount of foreign material per monitored volume of oil, wherein the sensor upon identification of the respective presence foreign material entrained within the oil at or a above a certain concentration causes a signal to be sent to the valve indicative of the command to open the valve.

10. The system to remove foreign matter from cooking oil of claim 9, wherein the valve automatically closes when either it is determined that all oil has drained from the overflow plenum or it is observed that an oil level within the overflow plenum has reached a position proximate to the bottom surface of the overflow plenum.

11. The system to remove foreign matter from cooking oil of claim 10, wherein a timer is initiated when the valve is initially opened and the valve is shut when the timer reaches an elapsed time that is representative of a determined time for the oil within a full overflow plenum to completely drain from the overflow plenum through the aperture.

12. The system to remove foreign matter from cooking oil of claim 7, further comprising a suction system disposed within a fluid pipe downstream of the valve, wherein when the valve is open and the suction system is operating oil is urged through the fluid connection due to both the operation of the suction system and the accumulated static pressure of the oil within the overflow plenum above a position of the fluid connection.

13. The system to remove foreign matter from cooking oil of claim 1, further comprising an oil transport system that is located proximate to the overflow plenum, wherein the oil transport system causes oil flow within the vat in a direction such that oil proximate to the overflow plenum is urged to enter into the overflow plenum.

14. The system to remove foreign matter from cooking oil of claim 1, wherein the overflow plenum comprises a first overflow plenum that is fixed to the vat proximate to the entry portion of the vat, and a second overflow plenum that is fixed to the vat proximate to the exit portion of the vat.

15. The system to remove foreign matter from cooking oil of claim 14, further comprising an exit conveyor proximate to the exit portion of the vat, wherein food exits the vat via the exit conveyor, wherein the exit conveyor extends above the second overflow plenum such that oil dripping from the exit conveyor and the food disposed upon the exit conveyor drips into the second overflow plenum.

16. The system to remove foreign matter from cooking oil of claim 1, wherein the overflow plenum is proximate to an exit portion of the vat, further comprising an exit conveyor proximate to the exit portion of the vat, wherein the exit conveyor extends above the overflow plenum such that oil dripping from the exit conveyor and the food disposed upon the exit conveyor drips into the overflow plenum.

17. An oil receiving system, comprising:
a housing that includes a front wall, a side wall, and a bottom wall, the front wall being configured to be connectable to an outer edge of a vat, the combined front wall, side wall, and bottom wall form a plenum for receipt of oil therein;
further comprising a fluid connection disposed in either the side wall or the bottom wall, the fluid connection vertically disposed below a top edge of the front wall,
further comprising a piped system that allows flow from within the plenum through the fluid connection;
a valve disposed at or proximate to the fluid connection and operable to either allow flow from the plenum through the fluid connection or prevent flow from the plenum through the fluid connection.

18. The oil receiving system of claim 17, further comprising an oil transport system that is movably fixed with respect to the front wall of the housing, the oil transport system selectively allows or prevents oil flow from the vat to the housing based upon an operational position of the oil transport system, wherein a first position prevents flow into the housing and a second position allows flow into the housing.

19. The oil receiving system of claim 17, wherein the oil transport system is a door that is pivotably mounted with respect to the housing, wherein when the door is in a first position, oil is prevented from flowing from a vat to the housing, and when the door is in the second position, oil is allowed to flow from the vat to the housing.
